(19) United States
(12) Patent Application Publication
(10) Pub. No.: US 2018/0155225 A1
(43) Pub. Date: Jun. 7, 2018

(54) INDIVIDUAL SEPTIC TANK UNIT

(71) Applicants: John R. Smith, Pittsburgh, PA (US); Ron Keffer, Harrison City, PA (US); Robert Horger, New Kensington, PA (US); Andrew C. Middleton, Mount Sidney, VA (US); Robin L. Weightman, Murrysville, PA (US)

(72) Inventors: John R. Smith, Pittsburgh, PA (US); Ron Keffer, Harrison City, PA (US); Robert Horger, New Kensington, PA (US); Andrew C. Middleton, Mount Sidney, VA (US); Robin L. Weightman, Murrysville, PA (US)

(21) Appl. No.: 15/835,343

(22) Filed: Dec. 7, 2017

Related U.S. Application Data
(60) Provisional application No. 62/431,417, filed on Dec. 7, 2016.

(51) Int. Cl. C02F 3/30; C02F 3/20; C02F 3/28; E03F 5/18

(52) U.S. Cl. CPC C02F 3/302; C02F 3/20; C02F 2101/16; E03F 5/18; C02F 2203/006; C02F 3/2866

(57) ABSTRACT

A septic tank system for a single household or small business. That system comprises: a compartment septic tank, at least one of a leach field and an infiltration pit, and a supplemental tank between the compartment septic tank and the leach field and/or the infiltration pit. The supplemental tank including means for converting ammonia to nitrogen gas, reducing biochemical oxygen demand and reducing total suspended solids. Preferably, it includes a first chamber having an air pump and aeration channels; and a second chamber for holding one or more solid phase organic media.

### CROSS-REFERENCE TO RELATED APPLICATION

This application is a perfection of U.S. Provisional Patent Application Ser. No. 62/431,417, filed on Dec. 7, 2016, the disclosure of which is fully incorporated by reference herein.

### FIELD OF THE INVENTIONS

### Background of the Inventions

These inventions all relate to improvements for conventional septic systems or septic tanks. More particularly, they relate to various methods and/or tank design variations/additions that will help improve the integrity and/or efficiency of overall conventional septic tank and related leach field operations.

Furthermore, it should be noted that all of the following improvements can be achieved with no additions of physical/mechanical variations (except for the possibility of an air pump in a few embodiments). They intend to be marketed under the NitROE tank brand trademark/service mark.

### Relevant Art

These improvements all represent significant advances over the current state of the art in septic tank technologies as shown in accompanying FIG. 1. Particularly therein, FIG. 1 shows what a “conventional” septic system includes. It is comprised of a septic tank for mainly solids separation via gravity settling and breakdown of organic N to ammonia and some organic breakdown as well, identified as BOD₅ (which stands for 5-day Biochemical Oxygen Demand. From that septic tank, wastewater gravity flows to a leach field. Via that step, there is further reduction of the BOD₅ and conversion of the ammonia to nitrate along with ˜26% conversion of the nitrate to nitrogen gas (N₂). However the remainder of the nitrate-N is then discharged to the subsurface via the bottom of the leach field.

For areas with very sandy soils, this nitrate-nitrogen can easily get into surface water bodies where they help enable algae growth that can have a negative effect on both the esthetics of the surface water and on the nearby fisheries due to habitat loss. Additional high nitrate levels discharged from such septic systems can also contaminate drinking water supplies with high nitrate-nitrogen levels. This problem is now recognized but to date there is really no cost efficient solution to this issue.

One company that has proposed a solution is Nitrex. Their system (as described at: http://lombardoassociates.com/nitrex.php)shows attempting to convert ammonia to nitrate via a suspended growth type process, then converting that nitrate nitrogen to nitrogen gas by passing the wastewater (or “ww”) through an organic based media.

Particularly, Nitrex™ nitrate-reactive media is meant to be contained in a prefabricated tank. For larger installations, that would be changed to an engineered excavation. Nitrate contaminated wastewaters are gravitationally fed through a treatment module with the aforementioned system. For septic tank applications, an oxidative pre-treatment step supposedly converts ammonium (NH₄⁺) to nitrate nitrogen (NO₃⁻) before a Nitrex-type filter can perform its reductive de-nitrification step. Such pre-treatments can be achieved with any of the existing oxidative technologies commonly used in (and associated with) wastewater treatment.

For Nitrex, the supposedly nitrate-free effluent from their filter is simply discharged to a conventional tile bed or receiving water body. Compared to other known technologies, the Nitrex filter is passive and claims to be essentially maintenance free. It is promised to provide almost 100% nitrate removal in a low cost, easy-to-install process.

Note also, Table 1 in the above-captioned website. There, competitive technologies to the Nitrex system are cited and their average effluent performances (in TN—which stands for total nitrogen that is a combination of organic nitrogen, ammonia nitrogen, nitrite nitrogen and nitrate nitrogen). Among those compared are the systems for: Biokreisel, EnviroServer, Amphidrome, Puraflo and Niteless.

### BRIEF SUMMARY OF THE INVENTIONS

There are several distinct concepts of septic tank improvements disclosed and claimed herein. They include:
1. adding a chambered tank between the septic tank and leach field, said chambered tank having a small (i.e., 30-120 watt) air pump included for adding supplemental oxygen to the system for enhancing and sustaining bacteria for ammonia-to-nitrate conversion;
2. adding a second (de-nitrifying) chamber to the first aeration tank above, said second chamber designed to hold wood chips and/or other solid phase organic media such supplied organics designed to enable the biological mediated process of de-nitrification;
3. adding an intentional automatic by-pass “loop” around the one or two chambered, intermediate tank as a fallback in case the intermediate tank unexpectedly clogs or otherwise functions less than preferred;
4. adding to the second (de-nitrifying) chamber a plurality of troughs for open water volumes, said troughs being kept free of any solid media, at least initially; note that such troughs can be two or more, sequentially located around, about and/or between adjoining solid media sub-chambers in the second de-nitrifying chamber;
5. providing an ability to insert vertical baffles, each having a plurality of apertures/holes that will allow AND direct the flow of water there through;
6. arranging this intermediate chamber (with just an aeration chamber, or in combination with one or more of the aforementioned de-nitrifying “optional” sub-chambers) so that the flow of water there through extends substantially horizontally, rather than with the known prior art systems of a vertical up flow or down flow of water there through;
7. providing the second, de-nitrifying chamber with a plurality of top ports through which: (a) one or more supplemental organics may be directly, or indirectly, added; and/or (b) an individual (preferably, a servicing technician) may be able to remove solid phase media from one or more of the open trough sub-sections of this de-nitrifying chamber. Representative supplemental organics include, but are not limited to: wood chips, wood, sawdust, sugar, cellulose, all seashell type materials and/or sulfur.
8. providing the second, de-nitrifying chamber with a plurality of pipe-like apparatus through which liquid and/or solid phase media may be added (i.e., “poured into”) one or more of the open water trough sub-chambers thereof. Such apparatus may take the form of: (a) a solid structure, like a PVC pipe; (b) a flexible hose-type structure; and (c) a concentric media system with an inner core of solid or liquid phase organics surrounded by an encasement of a second media source purposefully designed to “control” (i.e., slow down) the chemical diffusion of organics into these open water trough sub-chambers. The latter concentric media may take on the form of a booster stick/sock or snake that can be inserted, withdrawn and replaced, as needed, for supplying supplemental organics to the de-nitrifying bacteria of the overall system;
9. providing the second, de-nitrifying chamber with a plurality of substantially vertical pipes that would extend, at least partially, into the solid phase/wood chip media of this intermediate chamber addition to a typical septic tank/system, such vertical pipes being located at various points of the intermediate chamber while still being accessible from the surface;
10. providing the nitrifying chamber with a channel-like trench, one commercial type being “Polylok” or channel through which one or more sections of diffuser pipe may be inserted on an as needed (booster) basis. Ideally, such a trench could be secured to the bottom of this nitrifying chamber but allow for an air diffusion hose/tube to be inserted from the surface for accessing and efficient change out/replacement as needed;
11. such a diffuser pipe (with or without a trench) as cited in #10 above can also be inserted at the end of the de-nitrifying second chamber to reduce any supplemental organics present before final discharge due to that being present from the organic based media added.
12. providing a means of replacing a diffusion hose/tube/pipe by arranging a mean of removing the diffuser pipe from either end of the aeration trench by having rope attached to either end of the diffuser pipe with the rope accessible from the surface via either side of the aeration trench.
13. providing the nitrifying chamber with a combined mixture of both limestone and commercially available “bio-rings”. These may or may not be further supplemented with other alkalinity and carbonate/bicarbonate-containing media like crushed clams, oysters, scallop and related shells. Through these additions, supplemental alkalinity will be provided to the system for preferably keeping the overall pH at or near about a “neutral” range of between 6.5 and 8.

The main invention to be covered by this application concerns a septic tank system for a single household or small business. That system comprises: a compartment septic tank, at least one of a leach field and an infiltration pit, and a supplemental tank between the compartment septic tank and the leach field and/or the infiltration pit. The supplemental tank including means for converting ammonia to nitrogen gas, reducing biochemical oxygen demand and reducing total suspended solids. Preferably, it includes a first chamber having an air pump and aeration channels; and a second chamber for holding one or more solid phase organic media.

### SUMMARY OF THE DRAWINGS

Further features, objectives and advantages of these inventions will be more apparent when reviewing the following Detailed Description made with reference to the accompanying drawings in which:

FIG. 1 is a side-by-side comparison of the respective performances for a PRIOR ART system, one having an existing Septic Tank and a second that includes an existing Leach Field system, before the addition of any proposed improvements from this application;

FIG. 2 is a side-by-side comparison of the respective expected performances of the Septic Tank and Leach Field from FIG. 1 with one embodiment of this invention, an intermediate aeration chamber with air pump, inserted there between;

FIG. 3 is a side-by-side comparison of the respective expected performances of the Septic Tank and Leach Field from FIG. 2 with a de-nitrifying chamber added downstream of the intermediate aeration chamber;

FIG. 4 is a side-by-side comparison of the respective expected performances of the Septic Tank and Leach Field from FIG. 3 with an automatic by-pass added in the event of plugging or another aeration and/or de-nitrifying chamber malfunction (note—such an automatic by-pass can also be done via internal arrangements of baffle walls as well);

FIG. 5A is a top schematic view of one embodiment of this invention showing both an aeration chamber (to the left) and de-nitrifying chamber to its right with representative, relative dimensions therefor;

FIG. 5B is a side schematic view of the FIG. 5A embodiment as would be seen from the angle depicted at lines A-A of FIG. 5A;

FIG. 6A is a side schematic view of a second embodiment of this invention showing a removable aeration assembly extended therein; and FIG. 6B is a cross section end view of the FIG. 6A embodiment.

### DESCRIPTION OF PREFERRED EMBODIMENTS

### General NitROE™ Concepts

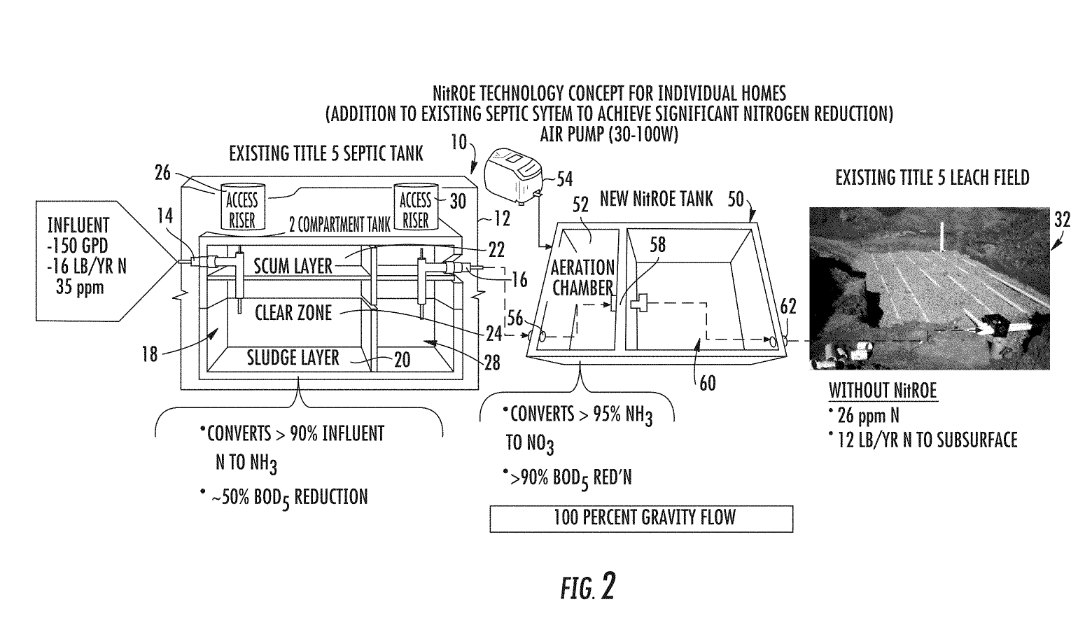

First Concept: Generally, the first improvement places an intermediate tank between an existing septic tank and the leach field. The purpose of such an intermediate addition is to significantly reduce the nitrate nitrogen that makes its way to the subsurface groundwater and then eventually to surface water bodies and/or groundwater used for potable purposes. As seen in FIG. 2, with its comparative performance rates (and anticipated improvements to those levels), with and without NitROE, this first chamber can be aerated with a small 30-120 W air pump for supplying supplemental oxygen to a new or existing septic tank system. That addition alone should enhance and sustain the bacteria that converts ammonia to nitrate in the system.

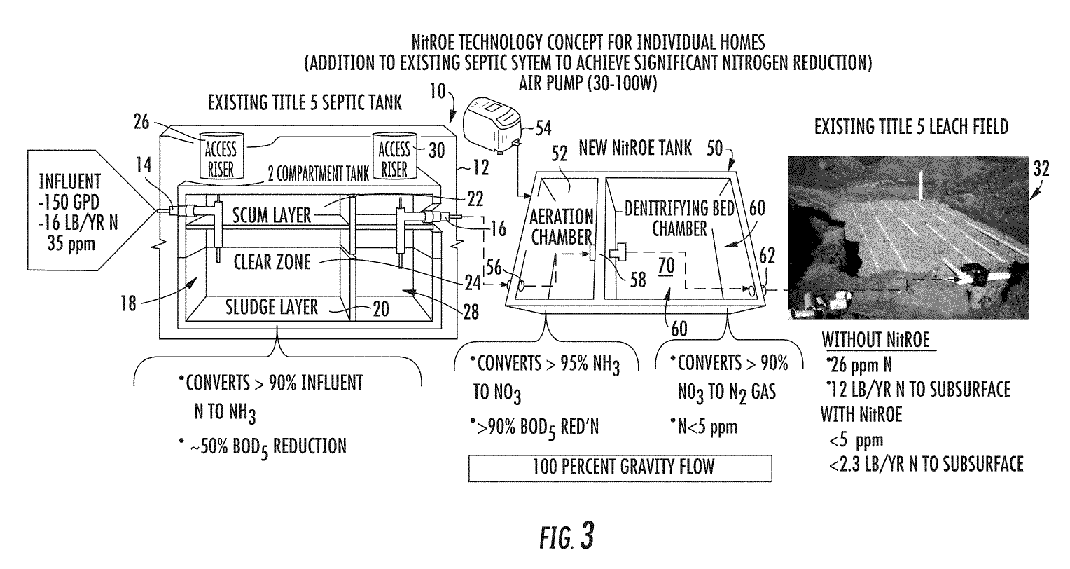

Second Concept: Per FIG. 3, a second NitROE sub-chamber is included, adjacent the aforementioned aeration chamber. This second would contain wood chips and other solid phase organic material for the purpose of supplying organics to help enable the biological mediated process of de-nitrification where the nitrate-N is converted to nitrogen (N₂) gas.

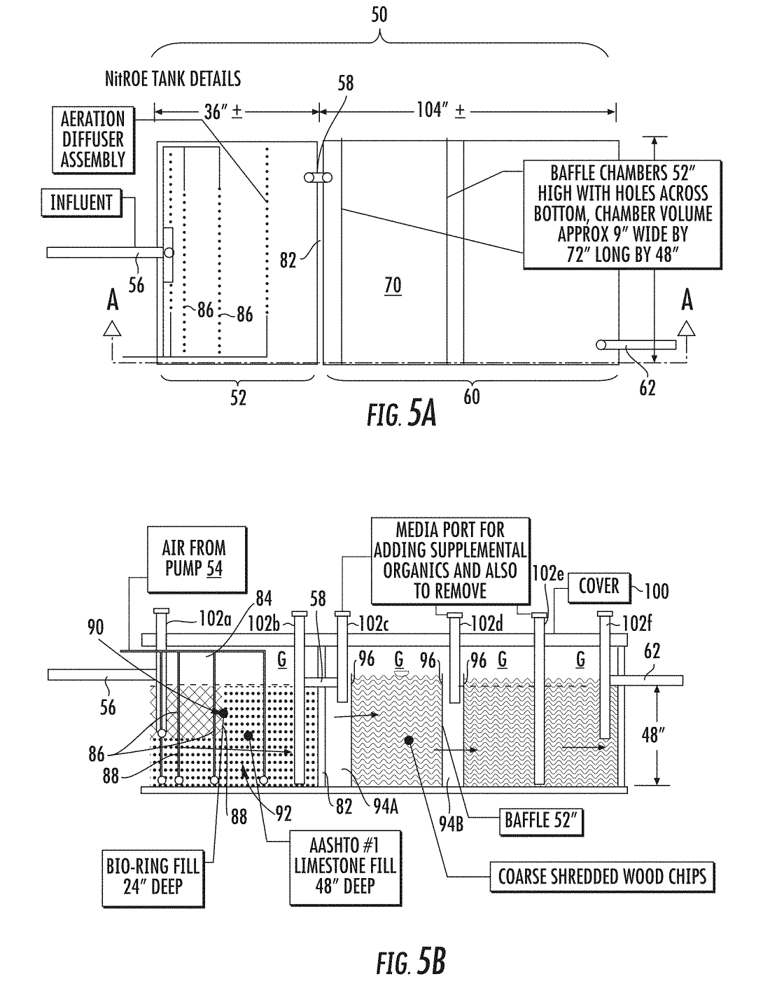

FIGS. 5A and B provide a more detailed schematic of the NitROE tank with these two chambers. With water flowing across the depth of the NitROE tank (per FIGS. 5A and B), the denitrifying chamber will have troughs that will not contain any media but will be open water volumes. Per FIGS. 5A and B, there will be one immediately after the first nitrifying chamber but also additional troughs can be located at different locations across the denitrifying chamber. FIGS. 5A and B show two representative troughs, but there could be as many as five, separate sub-troughs each ranging in relative widths from 6 to 24 inches.

Third Concept: FIGS. 5A and B also show the use of multiple vertical baffles, each baffle having multiple holes in them for allowing and directing water flow through the media contained in this sub-chamber.

Fourth Concept: Also of note is that most de-nitrifying media chambers are either down flow or up flow in design. The present design, by contrast, is a substantially horizontal flow as depicted with red arrows in FIG. 5B, as opposed to flow being more in a vertical up flow or down flow direction.

Fifth Concept: With such intermediate sub-chambers, solid and liquid phase media can be added into a plurality of top ports for making supplemental organic additions to assist/boost the denitrifying bacteria. Here, such solid phase and liquid phase media could be added by just pouring into the open water troughs as needed. These same ports could also be used to remove solid phase media from the open water troughs as needed. Such media could be any organic liquid and any solid media such as wood chips or other cellulose or even sulfur to help enable and support the denitrifying process.

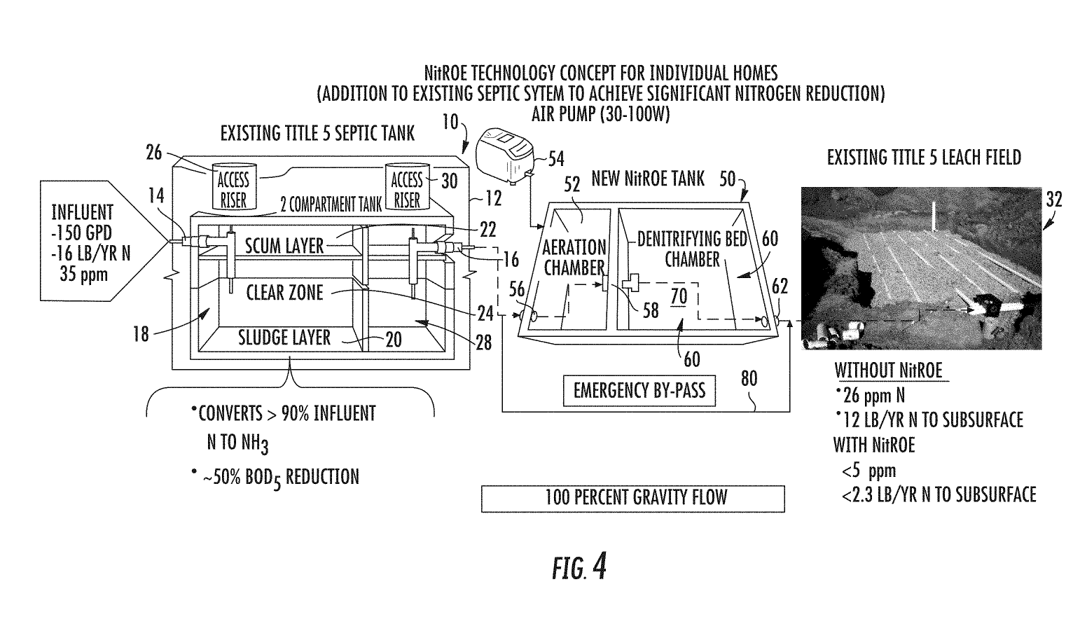

Sixth Concept: FIG. 4 illustrates that will also be an automatic by-pass to the NitROE cell should it ever get plugged and/or not function properly. Thus, at the very least, the wastewater will always be treated by the conventional and accepted Title 5 septic tank system.

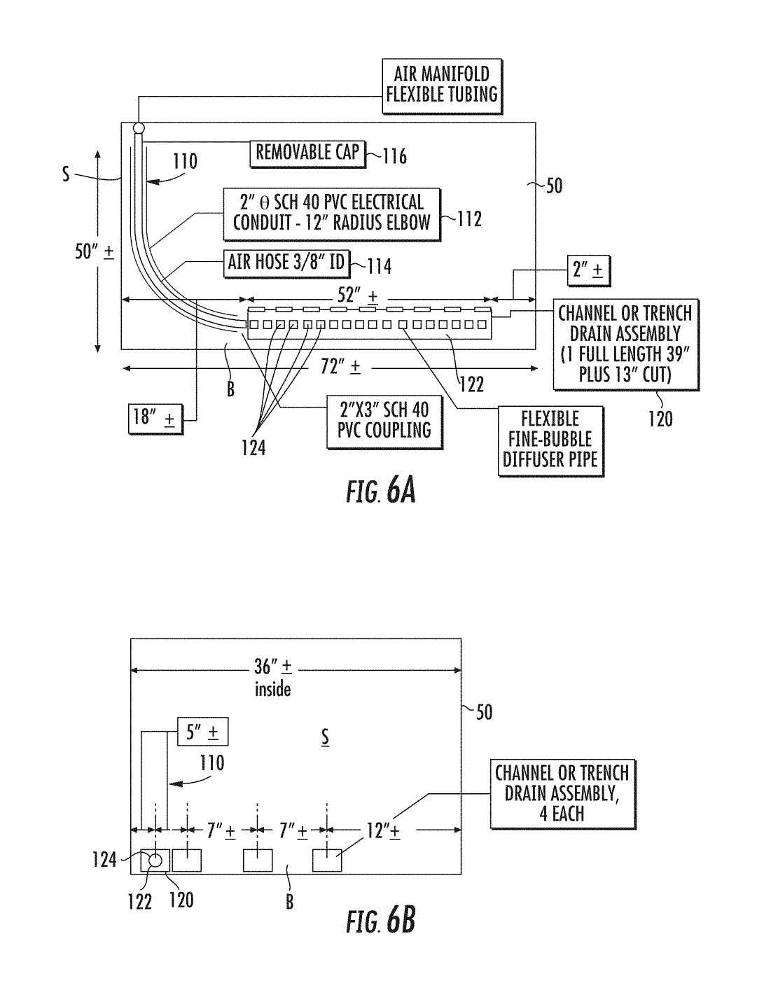

Seventh Concept: Per FIGS. 6A and B, the design of an alternate nitrifying chamber may include one or more Polylok™ trench-like channels into which a diffuser pipe may be inserted. With this configuration, a trench (that runs both vertically and horizontally) may be secured to the bottom of its chamber so long as an air diffusion hose may be kept accessible from the surface for efficient change out and replacement as needed. One or more of these trench like aeration channels could also be placed at the effluent of the de-nitrifying chamber to reduce any supplemental organics added via the organic based media added to the de-nitrifying chamber.

Eighth Concept: In addition to adding liquid and/or solid phase material loose into the open water troughs, such media could be added via a pipe-like apparatus where media could be added into the center of it where the organics would then be able to diffuse from the media into the open water trough. This pipe-like apparatus could be: (a) made of a solid structure such as PVC pipe; or (b) a flexible hose-type structure.

Ninth Concept: Alternately, an apparatus could be designed in a manner that it would have concentric media within it. One such embodiment would have a central core of solid or liquid phase organic completely surrounded with an outer encasement of another media designed to control the chemical diffusion of organics into the open water trough. Thereafter, a stick, sock or snake-like booster device could be added into the open water tough, withdrawn and replaced as needed to supply supplemental organics for the denitrifying bacteria.

That same stick, sock or snake-like device could also be added into a vertical pipe-like chamber already placed into the solid phase or wood chip media. Note, there could be multiple vertical pipes, located at different locations across the denitrifying chamber and accessible from the surface. Such vertical pipes could range in diameter size from 4 inch to 16 inch.

Tenth Concept: A first nitrifying aeration chamber could include a combined mixture of commercially available bio-rings and limestone. The limestone would provide supplemental alkalinity and thus buffering capacity since the biological process of nitrification does serve to generate acidity. With these limestone inclusions, the pH of the wastewater being treated could be reduced to a low value where the biological process of nitrification would not be negatively impacted. Limestone additions could take the pH of the wastewater to a preferred neutral range between about 6.5 to 8.

In place of, or in combination with limestone, still other alkalinity and carbonate/bicarbonate-containing media may be used including but not limited to: crushed clam, oyster, scallop and other such related shells.

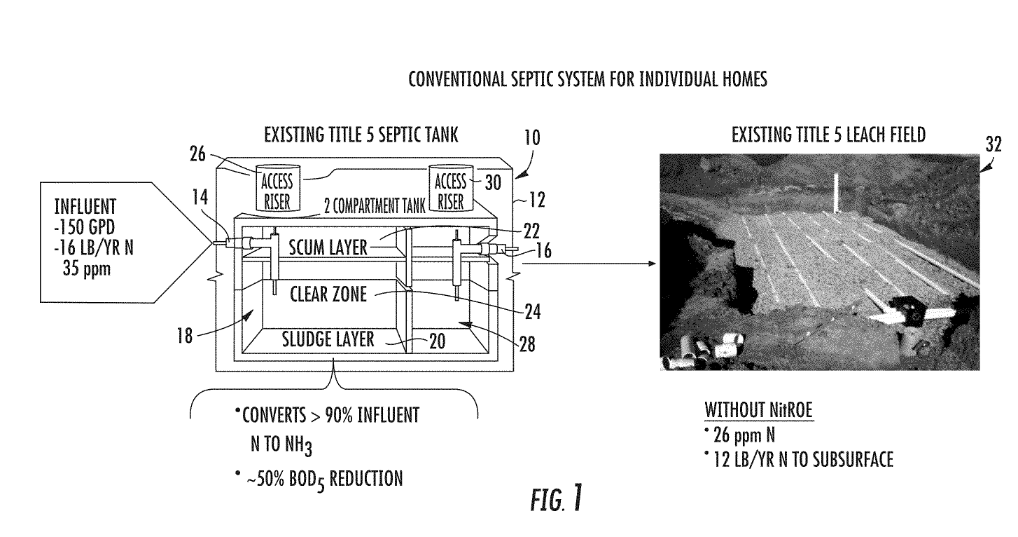

Referring now to the FIGS., there is shown in FIG. 1, a side-by-side comparison of the respective performances for a PRIOR ART system, the first system 10 (on the left side of the FIG. having an existing Septic Tank 12 with an inlet 14, an outlet 16 and two compartments, the first compartment 18 treating septic waste in multiple layers, namely a lowermost sludge layer 20, an uppermost scum layer 22 and clear zone 24 there between. A first riser 26 allows for access to the first compartment 18. Alternately, we could have a tank with no compartment walls (not shown). Output from that first compartment typically flows into a second compartment 28 that has its own access riser 30. The influent values and first compartment performance numbers shown on the left side of FIG. 1 are for a septic tank suitable for an individual home that meets applicable state and/or local standards.

Particularly, it takes an influent of about 150 GPD, with about 16 lb./yr. Nitrogen (35 ppm) and converts greater than about 90% of that influent N to NH₃, with about a 50% BOD₅ reduction therewith.

To further improve the performance of such known septic systems, there may be added to the tank 10 on the left side of FIG. 1, taking effluent from that tank and sending it into an existing regulatory compliant leach field 32. Alternately (or in addition thereto), the leach field may be replaced by (or supplemented with) an infiltration pit (not shown). Beneath the photograph of a representative leach field 32, in FIG. 1, there is listed the performance expectations of this PRIOR ART system (before the addition of a NitROE™ intermediate unit is combined therewith. Notably, the tank 10 and leach field 32 will produce a total N drop from 35 ppm to about 26 ppm and a change from 16 lb/yr (tank alone) to about 12 lb/yr N to the subsurface.

FIG. 2 is a side-by-side comparison of the respective expected performances of the septic tank 10 and leach field 32 from FIG. 1 to which one embodiment of new NitROE™ tank 50 has been added. Note, from FIG. 2 how this supplemental tank 50 includes at least one aeration chamber 52 to which a representative air pump 54 has been provided. That air pump should ideally operate at about 30-120 w.

Output from the main septic tank 10 enters the aeration chamber 52 of supplemental tank 50 via input port 56. It then somewhat horizontally flows through that aeration chamber before exiting at intermediate port 58 and flowing (by 100% gravity flow) into a second chamber 60. Instead of flowing through intermediate port 58, water can flow through a wall containing multiple holes to allow water to flow somewhat uniform and somewhat horizontally (not shown) into a second chamber 60. That chamber has no solid phase organic media added to it initially. After passing through this second chamber 60 of FIG. 2, effluent leaves the supplemental tank 50 via exit port 62 before passing along into the successor leach field 32 (and/or infiltration pit).

Note how well treatment performance improves with the addition of just an aeration chambered supplemental tank. That chamber 52 converts greater than 95% of the ammonia to NO₃ and achieves a greater than 90% reduction in BOD₅.

Performance further improves when the initially empty second chamber 60 to supplemental tank 50 of FIG. 2 is replaced with a purposefully added, denitrifying bed chamber 70. Particularly, with this alternate embodiment of the present invention, FIG. 3, a denitrifying bed chamber 70 within second chamber 60 converts greater than 90% NO3 to N2 gas and results in a total N content of less than 5 ppm. A side-by-side comparison, beneath the leach field 32 of FIG. 3, there is quantitatively shown how the addition of this version of NitROE™ supplemental tank takes N levels from 26 ppm to less than 5 ppm; and lowers N to subsurface levels from 12 lb./yr to less than 2.3 lb./yr.

FIG. 4 adds an emergency by-pass 80 to the supplemental tank 50. This by-pass is intended to provide continued flow to the leach field and/or the infiltration pit should any one or more chambers of the supplemental tank unexpectedly plug. One means for accomplishing such a by-pass is to allow for an upper flow gaping G of the respective partitions shown in FIGS. 5A and B such that fluids can effectively “jump” the respective partitions and flow atop the whole of supplemental chamber 50, from its inlet 56 to outlet 62, in the event of an unexpected emergency.

FIGS. 5A (top view) and 5B (side view) schematically show one preferred embodiment of supplemental tank 50 with one or more troughs and/or partitions (baffles) further separating the first aeration chamber 52 AND the denitrifying bed chamber 70 of second chamber 60 into further in-series sections, all having a substantially horizontal flow therethrough from entry to exit and all being 100% gravity flow driven. Note, while certain measurement/numbers are provided to FIGS. 5A through 6B, they are merely representative of one working example of supplemental tank 50 made and installed. It is NOT intended for the scope of this invention to be limited in any manner to such relative compartment sizes and shapes, etc.

With its multi-ported cover removed, FIG. 5A shows a top view of one version of supplemental tank 50 divided into unequally-sized sub-chambers, a forward located aeration chamber 52, separated by a intra-chamber partition 82, followed by the denitrifying bed chamber 70 of second chamber 60.

Air from air pump 54 gets delivered to the first aeration chamber 52 via air lines 84. First chamber 52 is further divided into sub-sections with one or more walls/partitions 86 (each having a plurality of apertures/holes, a representative one of which is labeled 88. Note also in FIG. 5B how the first chamber is filled, first with a bio-ring addition to the upper end, forward most section 90 before being surrounded beneath and behind section 90 with a substantial quantity of limestone fill 92.

Noteworthy is also how this preferred embodiment of supplemental tank 50 includes one or more troughs. See especially the troughs 94A (immediately following intra-chamber partition 82) and a second, more intermediate trough 94B.

Second chamber 60 of this supplemental tank 50 further includes one or more walls/sub-partitions (or baffles 96) for further compartmentalizing second chamber into sub-sections, one of which has coarse, shredded wood chips added thereto (as shown in FIG. 5B).

Across the entirety of supplemental tank 50 is a cover 100, best seen in the side view of FIG. 5B. Cover 100 has a plurality of access ports 102a through f, through which supplemental organic media may be added OR removed.

Finally, FIGS. 6A (side schematic view) and 6B (end view) of another embodiment of this invention show the addition of a purposefully removable aeration assembly 110 to at least one section of supplemental tank 50. That assembly comprises a section of conduit 112 into which an air hose 114 is inserted, having at one end a removable cap 116. That conduit 112 is meant to curve about a side wall S of the supplemental tank before extending along a section of bottom wall B where it will terminate in a channel (or trench 120) through which a section of diffuser pipe 122 extends, said diffuser pipe having a plurality of aeration holes 124.

1. A septic tank system for a single household or small business, said system comprising: a compartment septic tank, at least one of a leach field and an infiltration pit, and a supplemental tank between the compartment septic tank and the leach field and/or the infiltration pit, said supplemental tank including means for converting ammonia to nitrogen gas, reducing biochemical oxygen demand and reducing total suspended solids.

2. The tank system of claim 1 which uses 100% gravity flow from the compartment septic tank to the supplemental tank to the leach field and/or the infiltration pit.

3. The tank system of claim 1 wherein the supplemental tank includes at least one air pump for adding oxygen to the system.

4. The tank system of claim 1 wherein the supplemental tank is capable of providing continued flow to the leach field and/or the infiltration pit should any one or more chambers of the supplemental tank unexpectedly plug.

5. The tank system of claim 1 wherein the supplemental tank includes: a first chamber having an air pump and aeration channels; and a second chamber for holding one or more solid phase organic media.

6. The tank system of claim 5 wherein the first chamber is a nitrifying chamber and the second chamber is a denitrifying chamber.

7. The tank system of claim 5 wherein the solid phase organic media is selected from the group consisting of: wood chips, sawdust, sugar, cellulose, sulfur, and combinations thereof.

8. The tank system of claim 5 wherein at least one of the first chamber and the second chamber of the supplemental tank includes one or more troughs into which no solid phase organic media is initially added.

9. The tank system of claim 8 wherein the supplemental tank includes: at least one trough between the first chamber and the second chamber and at least one trough at or near an exit end of the second chamber.

10. The tank system of claim 8 wherein at least one of the troughs is provided with an additive selected from the group consisting of: a liquid phase organic, an alkalinity-rendering solid or liquid phase material, an aeration-promoting material and combinations thereof.

11. The tank system of claim 5 wherein the first chamber includes a mixture of limestone and bio-rings.

12. The tank system of claim 5 wherein at least one of the first chamber and the second chamber of the supplemental tank includes a plurality of vertical partitions, each partition having one or more apertures through which water flow is purposefully directed.

13. The tank system of claim 5 wherein the first chamber and the second chamber of the supplemental tank are arranged to allow water flow from the first chamber into and out of the second chamber in a substantially horizontal manner.

14. The tank system of claim 5 wherein the first chamber of the supplemental tank includes one or more channels through which one or more sections of diffuser pipe may be inserted.

15. In a septic tank system for a single household or small business that comprises a compartment septic tank and at least one of a leach field and an infiltration pit, the improvement which comprises: incorporating a supplemental tank between the compartment septic tank and the leach field and/or infiltration pit, said supplemental tank including at least one air pump for converting ammonia to nitrogen gas therein.

16. The improvement of claim 15 wherein the supplemental tank includes: a first nitrifying chamber having an air pump and aeration channels; and a second denitrifying chamber for holding one or more solid phase organic media.

17. The improvement of claim 16 wherein the solid phase organic media is selected from the group consisting of: wood chips, sawdust, sugar, cellulose, sulfur, and combinations thereof.

18. The improvement of claim 16 wherein the supplemental tank includes: at least one trough between the first chamber and the second chamber and at least one trough at or near an exit end of the second chamber.

19. The improvement of claim 16 wherein the first chamber includes a mixture of limestone and bio-rings.

20. The improvement of claim 16 wherein at least one of the first chamber and the second chamber of the supplemental tank includes a plurality of vertical partitions, each partition having one or more apertures through which water flow is purposefully directed.
